(19) United States
(12) Patent Application Publication
(10) Pub. No.: US 2026/0356388 A1
(43) Pub. Date: Nov. 12, 2026

(54) CONTROL SYSTEM

(71) Applicants: TOYOTA JIDOSHA KABUSHIKI KAISHA, Aichi-ken (JP); KOMATSU Ltd., Tokyo (JP)

(72) Inventors: Kosuke AKATSUKA, Toyota-shi (JP); Ruriko SAKAGUCHI, Toyota-shi (JP); Masahiro HARADA, Toyota-shi (JP); Yasuhiro OYAMA, Tokyo (JP); Takashi HIRANAKA, Tokyo (JP)

(21) Appl. No.: 19/660,235

(22) Filed: Apr. 28, 2026

(30) Foreign Application Priority Data
May 7, 2025 (JP) 2025-077406

(51) Int. Cl. B60W 50/14; B60W 60/00; G06V 10/94; G06V 20/58

(52) U.S. Cl. CPC B60W 50/14; B60W 60/001; G06V 10/945; G06V 20/58; B60W 2050/146; B60W 2420/403; B60W 2540/215; B60W 2556/40

(57) ABSTRACT

A control system for managing a predetermined area includes: processing circuitry; and an user interface. The processing circuitry acquires one or more images that are acquired by using a sensor mounted on an automated driving vehicle in the predetermined area and that indicate a situation around the automated driving vehicle in the predetermined area. The processing circuitry displays the one or more images on a display device of the user interface. The processing circuitry receives an operation that is input through the user interface to mark a portion in the one or more images. The processing circuitry registers the portion marked in the one or more images on map information of the predetermined area.

### CROSS-REFERENCES TO RELATED APPLICATION

The present disclosure claims priority to Japanese Patent Application No. 2025-077406, filed on May 7, 2025, the contents of which application are incorporated herein by reference in their entirety.

### TECHNICAL FIELD

The present disclosure relates to a technique for managing a predetermined area by using an automated driving vehicle.

### BACKGROUND ART

Patent Literature 1 discloses an autonomous vehicle control system. A camera is installed on a ceiling and captures an image of a travel environment including an obstacle from a bird's-eye view. A server acquires the image captured by the camera and identifies the obstacle in the travel environment based on the image. Further, the server automatically creates an environment map in which an entry prohibited area including the identified obstacle is set. The server provides the autonomous vehicle with the created environment map. The autonomous vehicle travels in the travel environment based on the environment map.

### LIST OF RELATED ART

Patent Literature 1: Japanese Patent Application Publication No. 2024-166875

### SUMMARY

Management of a predetermined area is considered. For example, it is useful to manage map information of a predetermined area. At this time, it is desirable that a administrator can register (reflect) desired information on the map information. However, in the technique described in Patent Literature 1, the administrator is not able to register desired information on the map information.

A first aspect relates to a control system for managing a predetermined area.

The control system includes: one or more processors; and an user interface.

The one or more processors acquire one or more images that are acquired by using a sensor mounted on an automated driving vehicle in the predetermined area and that indicate a situation around the automated driving vehicle in the predetermined area.

The one or more processors display the one or more images on a display device of the user interface.

The one or more processors receive an operation that is input through the user interface to mark a portion in the one or more images.

The one or more processors register the portion marked in the one or more images on map information of the predetermined area.

A second aspect relates to a control system for managing a predetermined area.

The control system includes: one or more processors; and an user interface.

The one or more processors acquire one or more images that are acquired by using a sensor mounted on an automated driving vehicle in the predetermined area and that indicate a situation around the automated driving vehicle in the predetermined area.

The one or more processors automatically extract a recommendation portion that is a portion in the one or more images and is recommended to be registered on map information of the predetermined area.

The one or more processors display the one or more images on a display device of the user interface while indicating the recommendation portion.

According to the first aspect, the control system displays the image indicating the situation around the automated driving vehicle in the predetermined area on the display device of the user interface. Moreover, the control system receives a marking operation to mark a portion in the image through the user interface. Then, the control system registers the marked portion in the image on the map information of the predetermined area. Due to such the marking function, an operator is able to efficiently register (reflect) desired information on the map information.

According to the second aspect, the control system acquires the image indicating the situation around the automated driving vehicle in the predetermined area. Further, the recommendation portion that is a portion in the image and is recommended to be registered on the map information of the predetermined area is automatically extracted. The control system displays the image on the display device of the user interface while indicating the recommendation portion. Due to such the recommendation function, an operator is able to easily register (reflect) desired information on the map information.

### BRIEF DESCRIPTION OF DRAWINGS

FIG. 1 is a conceptual diagram for explaining an example of a predetermined area being a target of management;

FIG. 2 is a conceptual diagram for explaining remote monitoring using an automated driving vehicle;

FIG. 3 is a conceptual diagram for explaining an overview of an area management system;

FIG. 4 is a conceptual diagram for explaining an outline of a marking function;

FIG. 5 is a conceptual diagram for explaining a first example of the marking function;

FIG. 6 is a conceptual diagram for explaining a second example of the marking function;

FIG. 7 is a conceptual diagram for explaining a third example of the marking function;

FIG. 8 is a conceptual diagram for explaining a fourth example of the marking function;

FIG. 9 is a block diagram illustrating an example of a configuration of an automated driving vehicle;

FIG. 10 is a conceptual diagram for explaining generation of a first image in an automated driving vehicle;

FIG. 11 is a conceptual diagram for explaining marking reference information;

FIG. 12 is a block diagram showing an example of a configuration of a control system;

FIG. 13 is a conceptual diagram for explaining a marking reception process in the control system;

FIG. 14 is a conceptual diagram for explaining an example of a registration process in the control system;

FIG. 15 is a conceptual diagram for explaining an example of a recommendation function; and

FIG. 16 is a block diagram showing an example of a functional configuration related to the recommendation function.

### DETAILED DESCRIPTION

Embodiments of the present disclosure will be described with reference to the accompanying drawings.

### 1. Management of Predetermined Area

Management of a predetermined area AR will be considered. The management is a concept including monitoring, maintenance, operation, investigation, information collection, information update, and the like. The predetermined area AR being a target of the management has a size at least large enough for a vehicle to travel. For example, the predetermined area AR is an outdoor area having a certain size.

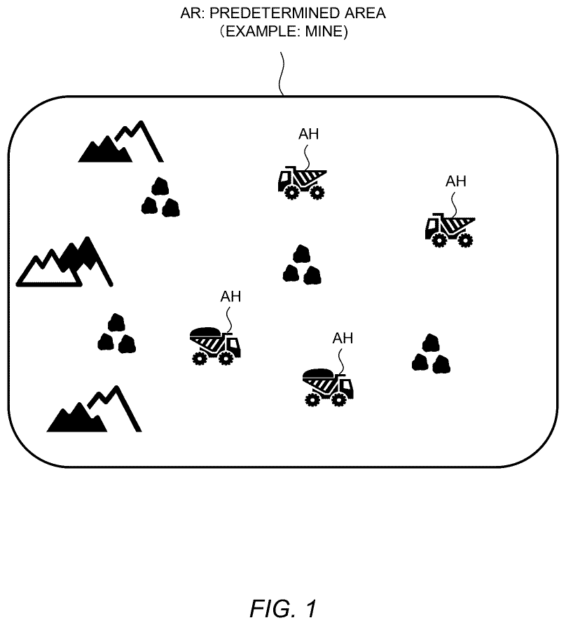

In an example shown in FIG. 1, the predetermined area AR is a working area of a mine. In the working area of the mine, in many cases, a road is unpaved and a surface of the road is sand or gravel. In the example shown in FIG. 1, an unmanned dump truck AH capable of autonomous traveling is used for a variety of works. It is important to manage the predetermined area AR so that such the unmanned dump truck AH is able to autonomously travel safely. For example, it is useful to correctly recognize a travelable area and a non-travelable area (i.e., a forbidden area) in the predetermined area AR. Therefore, it is useful to correctly recognize edges of banks and cliffs, that is, a boundary line between the travelable area and the non-travelable area. It is also useful to correctly recognize obstacles (e.g., fallen rocks, fallen objects, and the like) and irregularities (e.g., puddles, depressions, large ruts, and the like) on the road.

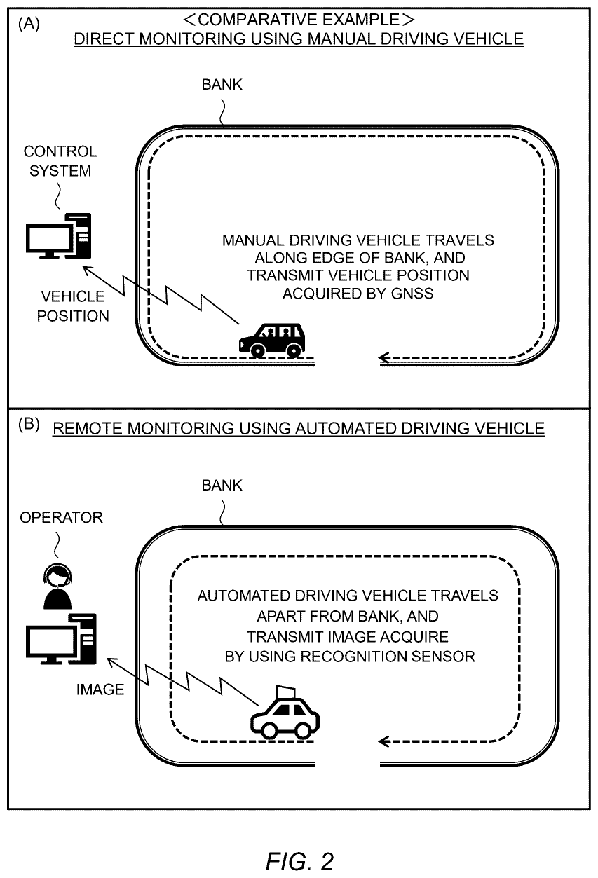

As an example, let us consider a work for recognizing an edge of a bank in the predetermined area AR (mine) with reference to FIG. 2, A part (A) in FIG. 2 illustrates a comparative example. In the comparative example, a manual driving vehicle (manned vehicle) is used. More specifically, a person gets on the vehicle and manually drives the vehicle so that the vehicle travels along the bank. The vehicle measures a vehicle position by using a GNSS (Global Navigation Satellite System) and continually transmits the vehicle position to a control system. The control system recognizes a group of vehicle positions, that is, a travel trajectory of the vehicle as an edge of the bank approximately. However, traveling of the manned vehicle along the bank involves risks. In addition, it is not preferable from a viewpoint of safety that the manned vehicle and the unmanned dump truck AH are mixed in the predetermined area AR.

On the other hand, a part (B) in FIG. 2 illustrates an example in which an automated driving vehicle (unmanned vehicle) is used. The automated driving vehicle is also referred to as an autonomous light vehicle (ALV). A recognition sensor such as a camera is mounted on the automated driving vehicle. The automated driving vehicle is able to recognize a surrounding situation by remote sensing using the recognition sensor. Therefore, the automated driving vehicle does not need to go close to the edge of the bank, and is able to recognize the edge of the bank from a position apart from the bank to some extent. The automated driving vehicle transmits an image obtained by using the recognition sensor to a control system. An operator views the image transmitted from the automated driving vehicle to recognize and check the edge of the bank. It should be noted that the operator can view the image to recognize and check the edge at any timing. The operator may check stored images at any convenient time and does not necessarily have to check the images in real time.

When the automated driving vehicle (i.e., the unmanned vehicle) is used as described above, it is not necessary for a person to get on the vehicle and go directly to a site, and a binding hour of the person is also shortened. These contribute to improvements in safety, efficiency, and productivity. In addition, it is not necessary to go close to the edge of the bank, which also contributes to improvement in safety.

From the above viewpoint, according to the present embodiment, the predetermined area AR is managed by using an automated driving vehicle.

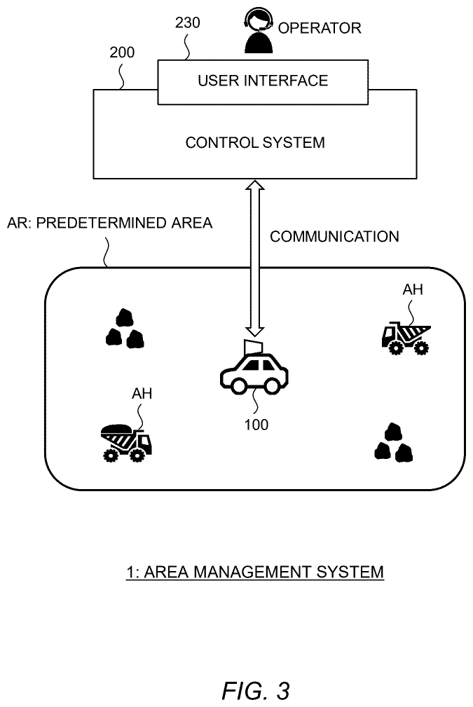

FIG. 3 is a conceptual diagram for explaining an overview of an area management system 1 according to the present embodiment. The area management system 1 is applied to the predetermined area AR and is configured to manage the predetermined area AR. More specifically, the area management system 1 includes an automated driving vehicle 100 and a control system (an information processing system) 200. The automated driving vehicle 100 is able to autonomously travel in the predetermined area AR. The autonomous driving (automated driving) here means that automatically performing steering, acceleration, and deceleration independently of an operation of a driver. The automated driving vehicle 100 is typically an unmanned vehicle. The control system 200 is an information processing system that is present outside the automated driving vehicle 100 and performs a variety of information processing. The automated driving vehicle 100 and the control system 200 can communicate with each other. The control system 200 manages the predetermined area AR and the automated driving vehicle 100.

The control system 200 according to the present embodiment is provided with a user interface 230 for providing a user interface function. The user interface 230 is configured to provide an operator (user) with a variety of information and to receive a variety of inputs from the user. To this end, the user interface 230 includes a display device and an input device. Hereinafter, the user interface function of the control system 200 according to the present embodiment will be described in more detail.

### 2. User Interface: Marking Function

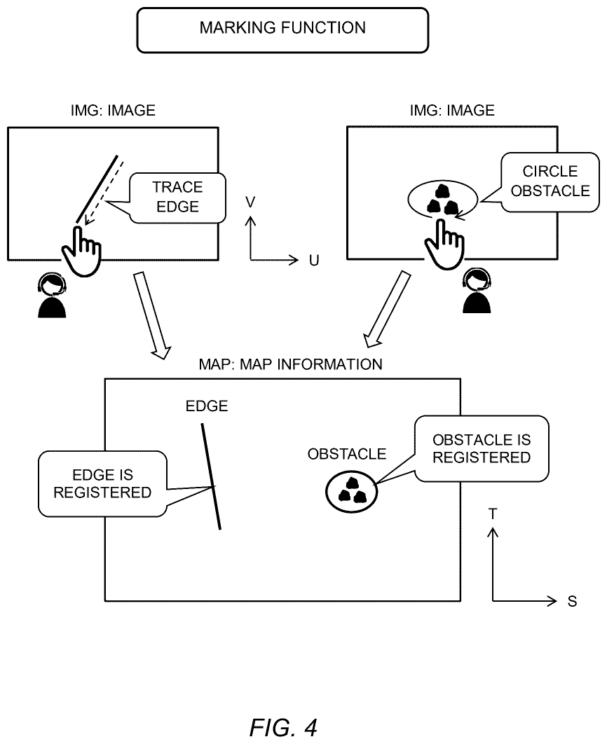

The control system 200 according to the present embodiment provides the operator with a “marking function” by using the user interface 230. An outline of the marking function will be described with reference to FIG. 4.

First, the control system 200 acquires one or more images IMG indicating a situation around the automated driving vehicle 100 in the predetermined area AR. The image IMG is acquired by using a recognition sensor mounted on the automated driving vehicle 100 in the predetermined area AR. Typically, the image IMG is transmitted from the automated driving vehicle 100 in the predetermined area AR to the control system 200. However, as long as the control system 200 can acquire the image IMG, the method is not limited. In any case, the control system 200 acquires one or more images IMG acquired by the automated driving vehicle 100 in the predetermined area AR. The control system 200 presents the acquired one or more images IMG to the operator by displaying the images IMG on the display device of the user interface 230.

The operator views the one or more images IMG displayed on the display device of the user interface 230. The operator can mark any portion in the displayed image IMG by using the input device of the user interface 230. The term “marking” can be rephrased as “designating”. Such an input operation of the operator for marking (designating) a portion in the image IMG is hereinafter referred to as a “marking operation”. For example, the operator focuses on an edge of a bank or a cliff in the image IMG and performs such a marking operation that traces the edge in the image IMG. As another example, the operator focuses on an obstacle in the image IMG and performs such a marking operation that circles the obstacle in the image IMG.

The control system 200 receives the marking operation that is input through the user interface 230. Then, the control system 200 registers (reflects) the “marked portion” marked by the marking operation on the map information MAP of the predetermined area AR. More specifically, the control system 200 converts a position of the marked portion in an image coordinate system (U, V) of the image IMG into a corresponding position in a map coordinate system (S, T) of the map information MAP (further details of the conversion process will be described later). Then, the control system 200 registers a portion at the corresponding position on the map information MAP as the marked portion. For example, when the operator performs such a marking operation that traces an edge in the image IMG, the traced portion is registered as the edge on the map information MAP. That is, the operator can draw the edge in the map information MAP by tracing the edge in the image IMG. As another example, when the operator performs such a marking operation that circles an obstacle in the image IMG, the circled portion is registered as the obstacle on the map information MAP.

After receiving the marking operation, the control system 200 may display and superpose the marked portion in the map coordinate system (S, T) on the map information MAP.

After receiving the marking operation, the control system 200 may check with the operator whether or not to register the marked portion on the map information MAP. When the operator finally determines to register the marked portion on the map information MAP, the control system 200 registers the marked portion on the map information MAP. The operator may redo the marking operation.

As described above, according to the present embodiment, the control system 200 displays the image IMG indicating the situation around the automated driving vehicle 100 in the predetermined area AR on the display device of the user interface 230. Moreover, the control system 200 receives the marking operation to mark a portion in the image IMG through the user interface 230. Then, the control system 200 registers the marked portion in the image IMG on the map information MAP of the predetermined area AR. Due to such the marking function, the operator is able to efficiently register (reflect) desired information on the map information MAP.

Various examples of the one or more images IMG and the marking function will be described below.

### 2-1. First Example

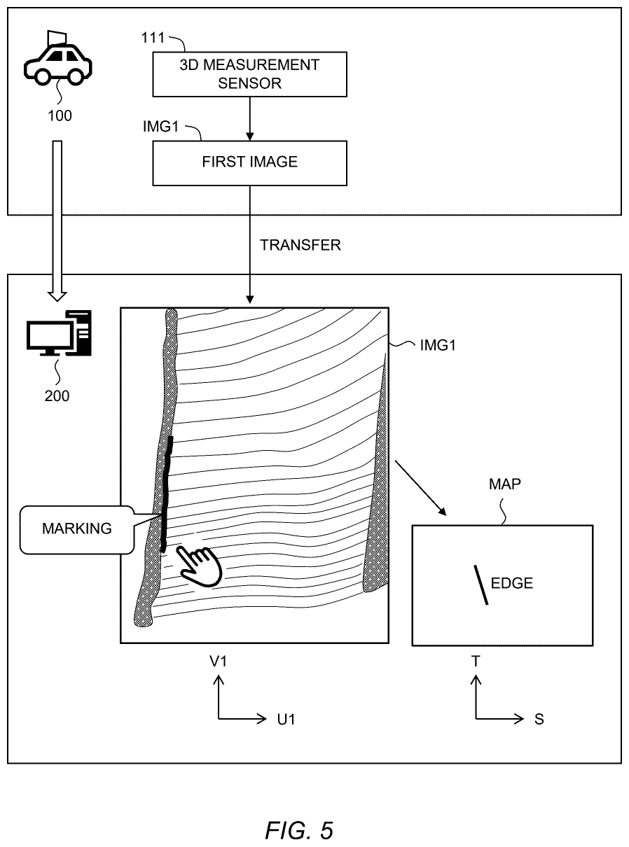

FIG. 5 is a conceptual diagram for explaining a first example of the marking function. A three dimensional measurement sensor 111 is mounted on the automated driving vehicle 100. The three dimensional measurement sensor 111 is configured to acquire three dimensional structure data around the automated driving vehicle 100. For example, the three dimensional measurement sensor 111 is a LIDAR (Laser Imaging Detection And Ranging). In the case of LIDAR, point cloud data around the automated driving vehicle 100 is obtained as the three dimensional structure data.

A first image IMG1 is the image IMG acquired by using the three dimensional measurement sensor 111. More specifically, the first image IMG1 is the image IMG of the three dimensional structure around the automated driving vehicle 100 in the predetermined area AR as viewed from above the automated driving vehicle 100. The first image IMG1 is generated by converting the three dimensional structure acquired by the three dimensional measurement sensor 111 into a two dimensional structure as viewed from the above. Further details of the first image IMG1 will be described later.

The automated driving vehicle 100 generates the first image IMG1 and transfers the first image IMG1 to the control system 200.

The control system 200 acquires the first image IMG1 from the automated driving vehicle 100. The control system 200 presents the acquired first image IMG1 to the operator by displaying the first image IMG1 on the display device of the user interface 230. The operator marks a first portion in the first image IMG1 by using the input device of the user interface 230. The control system 200 receives the marking operation input through the user interface 230. Then, the control system 200 registers (reflects) the first portion marked by the marking operation on the map information MAP of the predetermined area AR.

As described above, in the first example, the first image IMG1 acquired by using the three dimensional measurement sensor 111 is used. A position accuracy of an object shown in the first image IMG1 is high. Performing the marking operation with respect to such the first image IMG1 makes it possible to register a desired portion on the map information MAP with high accuracy.

### 2-2. Second Example

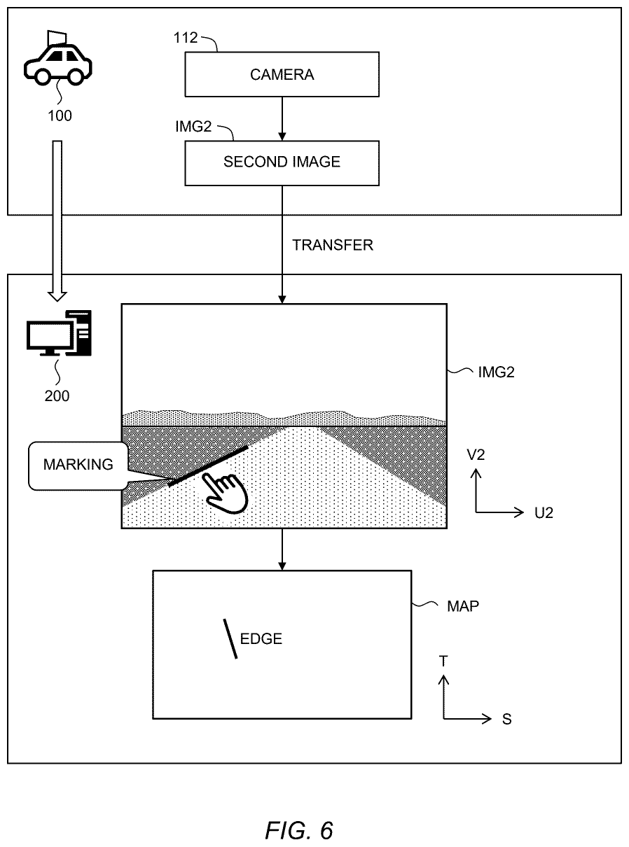

FIG. 6 is a conceptual diagram for explaining a second example of the marking function. A camera 112 that captures an image of the surroundings is mounted on the automated driving vehicle 100. A second image IMG2 is the image IMG captured by the camera 112 mounted on the automated driving vehicle 100 in the predetermined area AR. The automated driving vehicle 100 transfers the second image IMG2 to the control system 200.

The control system 200 acquires the second image IMG2 from the automated driving vehicle 100. The control system 200 presents the acquired second image IMG2 to the operator by displaying the second image IMG2 on the display device of the user interface 230. The operator marks a second portion in the second image IMG2 by using the input device of the user interface 230. The control system 200 receives the marking operation input through the user interface 230. Then, the control system 200 registers (reflects) the second portion marked by the marking operation on the map information MAP of the predetermined area AR.

As described above, in the second example, the second image IMG2 captured by the camera 112 is used. In the case of the second image IMG2, it is easy to grasp texture and physical properties of an objects shown in the image. This is advantageous in determining a portion to be registered on the map information MAP. Performing the marking operation with respect to such the second image IMG2 makes it possible to register an appropriate portion on the map information MAP.

### 2-3. Third Example

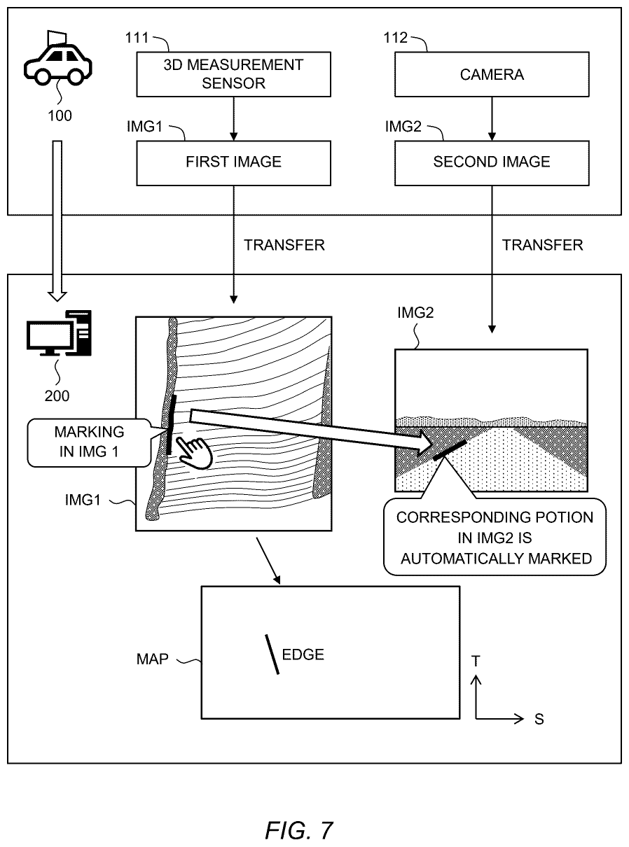

FIG. 7 is a conceptual diagram for explaining a third example of the marking function. The third example is a combination of the first example and the second example described above. The description overlapping with the first and second examples described above will be omitted as appropriate.

The automated driving vehicle 100 acquires both the first image IMG1 and the second image IMG2. Here, the first image IMG1 and the second image IMG2 are synchronized. That is, the first image IMG1 and the second image IMG2 show the situation around the automated driving vehicle 100 at the same timing. The automated driving vehicle 100 transfers the first image IMG1 and the second image IMG2 to the control system 200.

The control system 200 presents both the first image IMG1 and the second image IMG2 to the operator by displaying them on the display device of the user interface 230. The operator marks a first portion in the first image IMG1 by using the input device of the user interface 230. The control system 200 receives the marking operation input through the user interface 230.

A portion corresponding to the first portion marked in the first image IMG1 is present in the second image IMG2. A second portion in the second image IMG2 is the portion corresponding to the first portion marked in the first image IMG1. The control system 200 automatically marks the second portion in the second image IMG2 in response to the marking operation with respect to the first image IMG1. More specifically, the control system 200 converts a position of the first portion in a first image coordinate system (U1, V1) of the first image IMG1 into a corresponding position in a second image coordinate system (U2, V2) of the second image IMG2 (further details of the conversion process will be described later). Then, the control system 200 automatically marks a portion at the corresponding position in the second image IMG2 as the second portion.

As described above, in response to the marking operation with respect to the first image IMG1, a corresponding portion in the second image IMG2 is automatically marked. This allows the operator to double check the marked portion. As described above, the positional accuracy of the object shown in the first image IMG1 is high, and the texture and physical properties of the object shown in the second image IMG2 are easy to grasp. Checking the second portion in the second image IMG2 corresponding to the first portion marked in the first image IMG1 makes it possible to appropriately determine whether or not to register the first portion on the map information MAP.

When the operator finally determines to register the first portion on the map information MAP, the control system 200 registers the first portion on the map information MAP. The operator may redo the marking operation.

### 2-4. Fourth Example

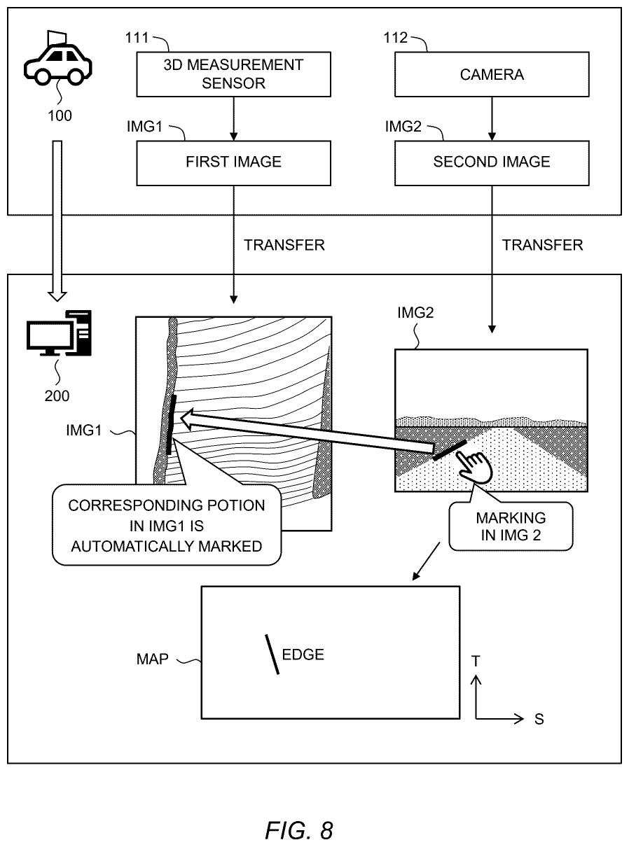

FIG. 8 is a conceptual diagram for explaining a fourth example of the marking function. The fourth example is a combination of the first example and the second example described above, and is the reverse of the third example described above. The description overlapping with the first to third examples described above will be omitted as appropriate.

The control system 200 presents both the first image IMG1 and the second image IMG2 to the operator by displaying them on the display device of the user interface 230. The operator marks a second portion in the second image IMG2 by using the input device of the user interface 230. The control system 200 receives the marking operation input through the user interface 230.

A portion corresponding to the second portion marked in the second image IMG2 is present in the first image IMG1. A first portion in the first image IMG1 is the portion corresponding to the second portion marked in the second image IMG2. The control system 200 automatically marks the first portion in the first image IMG1 in response to the marking operation with respect to the second image IMG2. More specifically, the control system 200 converts a position of the second portion in the second image coordinate system (U2, V2) of the second image IMG2 into a corresponding position in the first image coordinate system (U1, V1) of the first image IMG1 (further details of the conversion process will be described later). Then, the control system 200 automatically marks a portion at the corresponding position in the first image IMG1 as the first portion.

As described above, in response to the marking operation with respect to the second image IMG2, a corresponding portion in the first image IMG1 is automatically marked. This allows the operator to double check the marked portion. As described above, the positional accuracy of the object shown in the first image IMG1 is high, and the texture and physical properties of the object shown in the second image IMG2 are easy to grasp. Checking the first portion in the first image IMG1 corresponding to the second portion marked in the second image IMG2 makes it possible to appropriately determine whether or not to register the second portion on the map information MAP.

When the operator finally determines to register the second portion on the map information MAP, the control system 200 registers the second portion on the map information MAP. The operator may redo the marking operation.

### 3. Details of Automated Driving Vehicle

### 3-1. Configuration Example

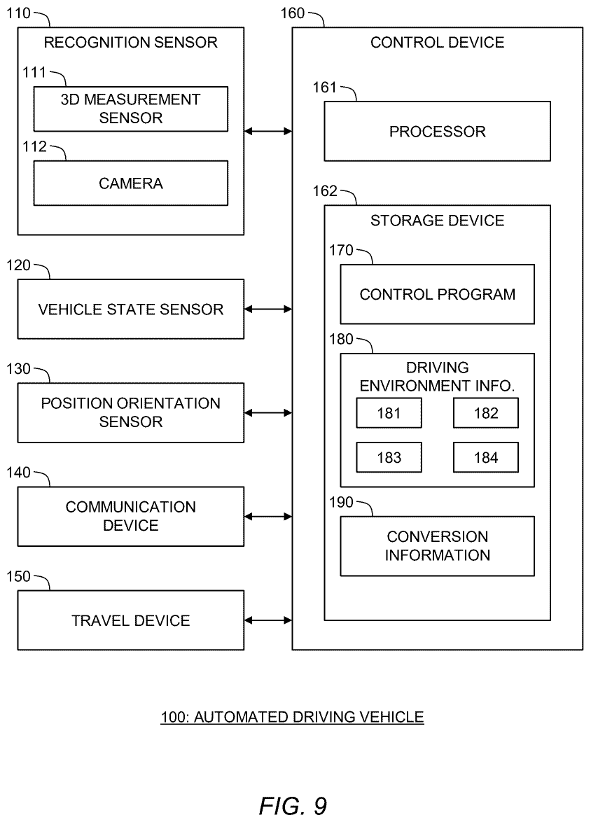

FIG. 9 is a block diagram showing an example of a configuration of the automated driving vehicle 100 according to the present embodiment. The automated driving vehicle 100 includes a recognition sensor 110, a vehicle state sensor 120, a position orientation sensor 130, a communication device 140, a travel device 150, and a control device 160.

The recognition sensor 110 recognizes (detects) a situation around the automated driving vehicle 100. The recognition sensor 110 includes one or more three dimensional measurement sensors 111, one or more cameras 112, and the like. The three dimensional measurement sensor 111 is configured to acquire three dimensional structure data around the automated driving vehicle 100. For example, the three dimensional measurement sensor 111 is a LIDAR (Laser Imaging Detection And Ranging). As another example, the three dimensional measurement sensor 111 may be a radar. The camera 112 captures an image of a situation around the automated driving vehicle 100. A plurality of cameras 112 (e.g., a front camera, a left camera, a right camera, and a rear camera) may be mounted on the automated driving vehicle 100.

The vehicle state sensor 120 detects a state of the automated driving vehicle 100. For example, the vehicle state sensor 120 includes a speed sensor, an acceleration sensor, a yaw rate sensor, a steering angle sensor, and the like.

The position orientation sensor 130 detects a position and an orientation (direction) of the automated driving vehicle 100 in the absolute coordinate system. For example, the position orientation sensor 130 includes a global navigation satellite system (GNSS), an inertial measurement unit (IMU), and the like.

The communication device 140 communicates with the outside via a communication network. For example, the communication device 140 communicates with the control system 200. Examples of the communication system include mobile communication such as 4G and 5G, and a wireless LAN.

The travel device 150 includes a steering device, a driving device, and a braking device. The steering device turns the wheels. For example, the steering device includes an electric power steering (EPS) device. The drive device is a power source that generates a driving force. Examples of the drive device include an engine, an electric motor, an in-wheel motor, and the like. The braking device generates a braking force.

The control device 160 is a computer that controls the automated driving vehicle 100. The control device 160 includes one or more processors 161 (hereinafter, simply referred to as a processor 161) and one or more storage devices 162 (hereinafter, simply referred to as a storage device 162). The processor 161 executes a variety of processing. Examples of the processor 161 include a general-purpose processor, a special-purpose processor, a central processing unit (CPU), a graphics processing unit (GPU), an application specific integrated circuit (ASIC), a field-programmable gate array (FPGA), and the like. The processor 161 may also be referred to as processing circuitry. The storage device 162 stores a variety of information. Examples of the storage device 162 include a volatile memory, a nonvolatile memory, a hard disk drive (HDD), a solid state drive (SSD), and the like.

A control program 170 is a computer program for controlling the automated driving vehicle 100. The functions of the control device 160 may be realized by a cooperation of the processor 161 executing the control program 170 and the storage device 162. The control program 170 is stored in the storage device 162. Alternatively, the control program 170 may be recorded on a non-transitory computer-readable recording medium.

The control device 160 acquires driving environment information 180 indicating a driving environment for the automated driving vehicle 100. The driving environment information 180 is stored in the storage device 162. The driving environment information 180 includes surrounding situation information 181, vehicle state information 182, position orientation information 183, and map information 184.

The surrounding situation information 181 is information acquired based on a result of recognition by the recognition sensor 110, and indicates the situation around the automated driving vehicle 100. The control device 160 recognizes the situation around the automated driving vehicle 100 by using the recognition sensor 110 to acquire the surrounding situation information 181. For example, the surrounding situation information 181 includes the three dimensional structure data (point cloud data) acquired by the three dimensional measurement sensor 111. As another example, the surrounding situation information 181 includes an image captured by the camera 112.

The surrounding situation information 181 may further include object information regarding an object around the automated driving vehicle 100. Examples of the object include another vehicle, a bank, a cliff, an obstacle, and the like. The object information indicates a relative position and a relative speed of the object with respect to the automated driving vehicle 100. For example, analyzing the image obtained by the camera 112 makes it possible to identify an object and calculate the relative position of the object. Furthermore, it is also possible to identify an object and acquire the relative position and the relative speed of the object based on the three dimensional structure data (point cloud data) acquired by the three dimensional measurement sensor 111.

The vehicle state information 182 is information detected by the vehicle state sensor 120 and indicates the state of the automated driving vehicle 100. The states of the automated driving vehicle 100 include a vehicle speed, an acceleration, a yaw rate, a steering angle, and the like. The control device 160 acquires the vehicle state information 182 from the vehicle state sensor 120.

The position orientation information 183 indicates the position and the orientation of the automated driving vehicle 100 in the absolute coordinate system. The control device 160 acquires the position orientation information 183 from a result of detection by the position orientation sensor 130.

The map information 184 indicates a map of the predetermined area AR. The map information 184 may be the same as the map information MAP managed by the control system 200. The map information 184 is provided from the control system 200. The control device 160 communicates with the control system 200 via the communication device 140 and acquires the map information 184.

The control device 160 communicates with the control system 200 via the communication device 140. The control device 160 may transmit at least a part of the driving environment information 180 to the control system 200. For example, the control device 160 may transmit the image captured by the camera 112 to the control system 200 in real time. The control device 160 may transmit the vehicle state information 182 to the control system 200 in real time. The control device 160 may transmit the position orientation information 183 to the control system 200 in real time.

Moreover, the control device 160 executes vehicle travel control for controlling travel of the automated driving vehicle 100. The vehicle travel control includes steering control, acceleration control, and deceleration control. The control device 160 executes the vehicle travel control by controlling the travel device 150 (i.e., the steering device, the drive device, and the braking device).

Furthermore, the control device 160 executes automated driving control for controlling automated driving of the automated driving vehicle 100. More specifically, the control device 160 generates a travel plan of the automated driving vehicle 100 based on the driving environment information 180. The travel plan includes a path plan and a speed plan of the automated driving vehicle 100. The path plan is a group of target positions of the automated driving vehicle 100. The speed plan is a set of target speeds for each target position. A combination of the path plan and the speed plan is also referred to as a “target trajectory”. That is, the target trajectory includes the target position and the target speed of the automated driving vehicle 100. The control device 160 executes the vehicle travel control such that the automated driving vehicle 100 follows the target trajectory.

### 3-2. Monitoring Travel Mode

When monitoring the predetermined area AR, the automated driving vehicle 100 is set to a monitoring travel mode. For example, the operator uses the user interface 230 of the control system 200 to instruct start of the monitoring travel mode. The control system 200 communicates with the automated driving vehicle 100 and instructs the automated driving vehicle 100 to start the monitoring travel mode. The control device 160 of the automated driving vehicle 100 starts the monitoring travel mode in response to the instruction from the control system 200. The control device 160 executes the automated driving control such that the automated driving vehicle 100 autonomously travels in the predetermined area AR.

A target travel route in the predetermined area AR may be designated in advance by the operator. In this case, the operator uses the user interface 230 of the control system 200 to input the target travel route in the predetermined area AR. The control system 200 communicates with the automated driving vehicle 100 and provides the automated driving vehicle 100 with information on the target travel route. The control device 160 of the automated driving vehicle 100 executes the automated driving control such that the automated driving vehicle 100 follows the target travel route.

During the monitoring travel mode, the control device 160 may transmit at least a part of the driving environment information 180 to the control system 200. For example, the control device 160 may transmit the image captured by the camera 112 to the control system 200 in real time. The control device 160 may transmit the vehicle state information 182 to the control system 200 in real time. The control device 160 may transmit the position orientation information 183 to the control system 200 in real time.

### 3-2-1. Target Detection Process

During the monitoring travel mode, the control device 160 recognizes the situation around the automated driving vehicle 100 by using the recognition sensor 110 to acquire the surrounding situation information 181. For example, the surrounding situation information 181 includes the image captured by the camera 112. The surrounding situation information 181 may include the three dimensional structure data (i.e., the point cloud data) acquired by the three dimensional measurement sensor 111.

Examples of a “target” to be particularly focused on in the predetermined area AR include a bank, a cliff, an obstacle (for example, a fallen stone, a fallen object, and the like), irregularity (for example, a puddle, a depression, a large rut, and the like), etc. The control device 160 detects presence of such a target on the basis of the surrounding situation information 181. For example, a machine learning model (AI model) that is configured to detect a target from the surrounding situation information 181 is prepared in advance and stored in the storage device 162. The control device 160 is able to automatically detect a target around the automated driving vehicle 100 by inputting the surrounding situation information 181 to the machine learning model.

### 3-2-2. Target Image Acquisition Process

When the target around the automated driving vehicle 100 is detected, the control device 160 acquires an image IMG (target image) including the detected target. For example, the image IMG (target image) includes the second image IMG2 captured by the camera 112. As another example, the image IMG (target image) may include the first image IMG1 of the three dimensional structure around the automated driving vehicle 100 as viewed from above the automated driving vehicle 100.

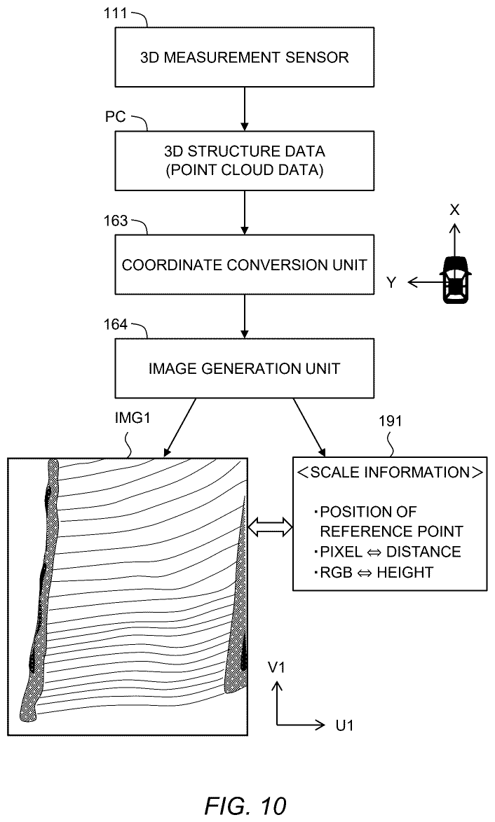

FIG. 10 is a conceptual diagram for explaining generation of the first image IMG1 in the automated driving vehicle 100. The three dimensional measurement sensor 111 acquires the three dimensional structure data PC (the point cloud data) around the automated driving vehicle 100. The three dimensional structure data PC is represented in a sensor coordinate system of the three dimensional measurement sensor 111.

A coordinate conversion unit 163 of the control device 160 performs coordinate conversion from the sensor coordinate system to a vehicle coordinate system (X, Y, Z). The vehicle coordinate system (X, Y, Z) is a coordinate system fixed to the automated driving vehicle 100. The X direction represents a forward direction, the Y direction represents a lateral direction, and the Z direction represents a vertical direction. Installation information (i.e., an installation position and an installation orientation) of the three dimensional measurement sensor 111 in the vehicle coordinate system (X, Y, Z) of the automated driving vehicle 100 is known information. A coordinate transformation matrix between the sensor coordinate system and the vehicle coordinate system (X, Y, Z) is determined in advance based on the installation information (i.e., the installation position and the installation orientation) of the three dimensional measurement sensor 111 in the vehicle coordinate system (X, Y, Z). Information on the coordinate transformation matrix is stored in the storage device 162 in advance. The coordinate conversion unit 163 converts the three dimensional structure data PC in the sensor coordinate system into three dimensional structure data PC in the vehicle coordinate system (X, Y, Z) by using the coordinate transformation matrix.

Subsequently, an image generation unit 164 of the control device 160 generates the first image IMG1 from the three dimensional structure data PC in the vehicle coordinate system (X, Y, Z). That is, the image generation unit 164 generates the first image IMG1 by converting the three dimensional structure in the vehicle coordinate system (X, Y, Z) into two dimensional data as viewed from the above. In other words, the image generation unit 164 generates the first image IMG1 by rendering the three dimensional structure in the vehicle coordinate system (X, Y, Z) while viewing from the above.

In the first image IMG1, height (i.e., a value in the Z direction) of the three dimensional structure around the automated driving vehicle 100 may be represented by color (RGB). That is, the first image IMG1 may be a color map image that represents the height of the three dimensional structure by color while representing plane positions of the three dimensional structure. A correspondence relationship between the height (Z) and the color (RGB) is predefined. Information on the correspondence relationship is stored in advance in the storage device 162. The image generation unit 164 converts the height (Z) of the three dimensional structure into the color (RGB) on the basis of the information on the correspondence relationship to generate the first image IMG1.

The image generation unit 164 generates the first image IMG1 and also generates scale information 191 regarding the first image IMG1. The scale information 191 is information for associating a point (pixel) on the first image IMG1 with a point in the vehicle coordinate system (X, Y, Z). In other words, the scale information 191 is conversion information for performing the coordinate conversion between the first image coordinate system (U1, V1) of the first image IMG1 and the vehicle coordinate system (X, Y, Z). For example, the scale information 191 indicates a position (pixel) of the origin of the vehicle coordinate system (X, Y, Z) in the first image IMG1. The origin of the vehicle coordinate system (X, Y, Z) can also be referred to as a reference point. In addition, the scale information 191 indicates a correspondence relationship between a single pixel on the first image IMG1 and an actual distance. Further, the scale information 191 indicates a correspondence relationship between the color (RGB) of the pixel on the first image IMG1 and the height (Z) in the vehicle coordinate system. The scale information 191 is used for marking processing in the control system 200.

The image IMG is acquired at a first timing. In other words, the image IMG shows the situation around the automated driving vehicle 100 at the first timing. The control device 160 retains the position orientation information 183 at the first timing at which the image IMG is acquired. The position orientation information 183 indicates the position and the orientation of the automated driving vehicle 100 in the map coordinate system. The position orientation information 183 at the first timing is also used for the marking processing in the control system 200.

It should be noted that in order to suppress “blurring” of the image IMG, an upper limit value may be set for the speed of the automated driving vehicle 100 when acquiring the image IMG. The upper limit value is set to be low so that the “blurring” of the image IMG is sufficiently suppressed. When acquiring the image IMG, the automated driving vehicle 100 may be stopped (that is, the upper limit value =0). When the target around the automated driving vehicle 100 is detected, the control device 160 decelerates the automated driving vehicle 100 so that the speed becomes equal to or less than the upper limit value, and then acquires the image IMG.

### 3-2-3. Information Transmission Process

After acquiring the image IMG, the control device 160 communicates with the control system 200 via the communication device 140, and transmits “marking reference information REF” to the control system 200.

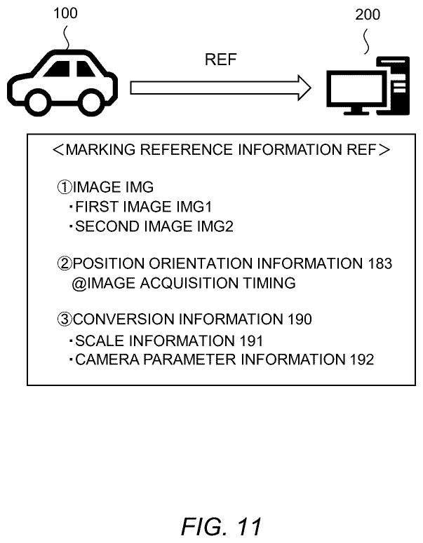

FIG. 11 is a conceptual diagram for explaining the marking reference information REF. The marking reference information REF includes one or more images IMG acquired by the target image acquisition process described above. The one or more images IMG include at least one of the first image IMG1 and the second image IMG2. Moreover, the marking reference information REF includes the position orientation information 183 at the first timing at which the image IMG is acquired.

Further, the marking reference information REF includes conversion information 190. The conversion information 190 is information for performing the coordinate conversion between the image coordinate system (U, V) of the image IMG and the vehicle coordinate system (X, Y, Z). For example, the conversion information 190 includes the scale information 191 for performing the coordinate conversion between the first image coordinate system (U1, V1) of the first image IMG1 and the vehicle coordinate system (X, Y, Z).

The conversion information 190 may include camera parameter information 192 regarding the camera 112 mounted on the automated driving vehicle 100. Camera parameters include intrinsic parameters and extrinsic parameters. The intrinsic parameters include a distortion parameter, a focal length, and the like. The external parameters include the installation position and the installation orientation of the camera 112 in the vehicle coordinate system (X, Y, Z). It should be noted that the camera parameter information 192 may be retained in the control system 200 in advance. In this case, the camera parameter information 192 does not need to be transmitted from the automated driving vehicle 100 to the control system 200.

### 4. Control System

### 4-1. Configuration Example

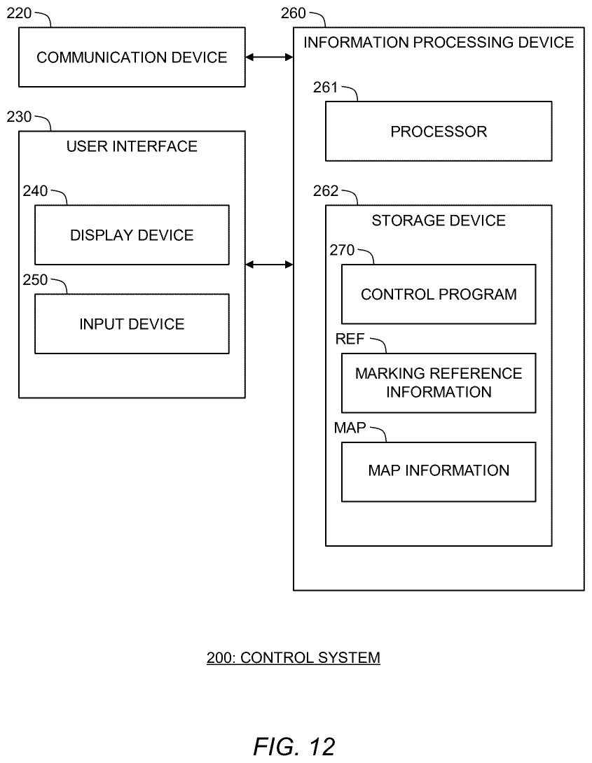

FIG. 12 is a block diagram showing an example of a configuration of the control system 200 according to the present embodiment. The control system 200 is configured by one or more nodes. The control system 200 includes a communication device 220, a user interface 230, and an information processing device 260.

The communication device 220 performs a communication via a communication network. For example, the communication device 220 communicates with the automated driving vehicle 100 in the predetermined area AR. Examples of the communication system include mobile communication such as 4G and 5G, and a wireless LAN.

The user interface 230 is configured to provide (present) a variety of information to the operator (user) and to receive a variety of input from the user. The user interface 230 includes a display device 240 and an input device 250. Examples of the display device 240 include a display, a touch panel, a head-up display, and the like. Examples of the input device 250 include a touch panel, a mouse, a keyboard, a microphone, and the like. The display device 240 and the input device 250 may be the same touch panel.

The information processing device 260 includes one or more processors 261 (hereinafter, simply referred to as a processor 261) and one or more storage devices 262 (hereinafter, simply referred to as a storage device 262). The processor 261 executes a variety of processing. Examples of the processor 261 include a general-purpose processor, a special-purpose processor, a CPU, a GPU, an ASIC, an FPGA, and the like. The processor 261 may also be referred to as processing circuitry. The storage device 262 stores a variety of information. Examples of the storage device 262 include a volatile memory, a nonvolatile memory, an HDD, an SSD, and the like. For example, the storage device 262 stores the map information MAP of the predetermined area AR.

The information processing device 260 (the processor 261) is able to communicate with the automated driving vehicle 100 via the communication device 220. The information processing device 260 receives the above-described marking reference information REF transmitted from the automated driving vehicle 100. The information processing device 260 may receive the marking reference information REF in real time. The marking reference information REF is stored in the storage device 262. The information processing device 260 may receive the driving environment information 180 transmitted from the automated driving vehicle 100.

Moreover, the information processing device 260 (the processor 261) is able to provide (present) a variety of information to the operator via the user interface 230 (the display device 240). Further, the information processing device 260 (the processor 261) is able to receive a variety of inputs from the operator via the user interface 230 (the input device 250).

A control program 270 is a computer program for controlling the control system 200. The functions of the information processing device 260 may be realized by a cooperation between the processor 261 executing the control program 270 and the storage device 262. The control program 270 is stored in the storage device 262. Alternatively, the control program 270 may be recorded on a non-transitory computer-readable recording medium.

### 4-2. Information Display Process

The information processing device 260 displays the one or more images IMG included in the marking reference information REF acquired from the automated driving vehicle 100 on the display device 240. The one or more images IMG include at least one of the first image IMG1 and the second image IMG2.

The information processing device 260 may receive the image IMG from the automated driving vehicle 100 in real time and display the received image IMG on the display device 240. When the image IMG is received from the automated driving vehicle 100, the information processing device 260 may issue a notification to the operator through the user interface 230. The notification may be visible information displayed on the display device 240 or may be audio information output from the speaker.

Moreover, the information processing device 260 displays the map information MAP of the predetermined area AR on the display device 240.

Further, the information processing device 260 may display the driving environment information 180 acquired from the automated driving vehicle 100 on the display device 240.

### 4-3. Marking Reception Process

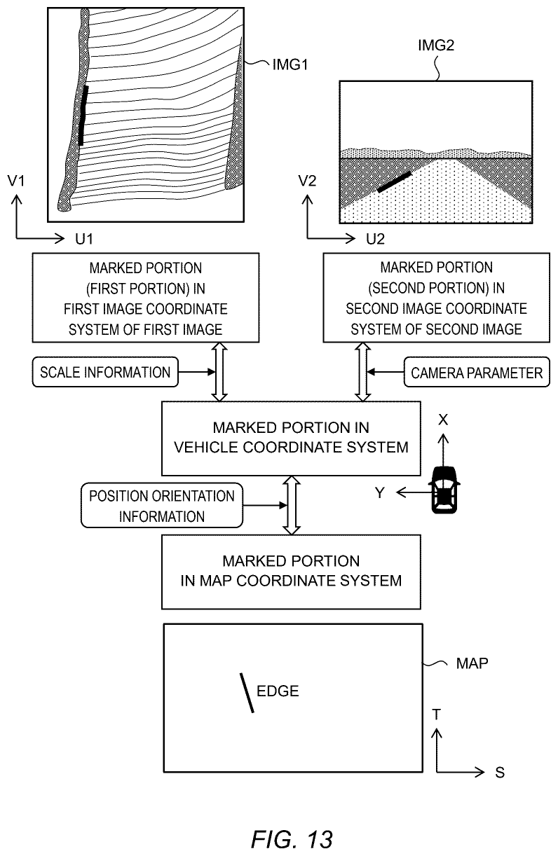

FIG. 13 is a conceptual diagram for explaining a marking reception process. The information processing device 260 receives a marking operation that is input through the input device 250.

For example, the operator marks a first portion in the first image IMG1 by using the input device 250. The information processing device 260 acquires information on the first portion in the first image IMG1. The information on the first portion in the first image IMG1 includes an in-image position (pixel) of the first portion in the first image IMG1. Moreover, the information on the first portion in the first image IMG1 includes the color (RGB) of the first portion in the first image IMG1. Based on the scale information 191, the information processing device 260 calculates a position of the first portion in the vehicle coordinate system (X, Y, Z) from the information on the first portion in the first image IMG1. More specifically, the scale information 191 includes the position of the origin of the vehicle coordinate system (X, Y, Z) in the first image IMG1 and the correspondence relationship between a single pixel on the first image IMG1 and an actual distance. Based on such the scale information 191, it is possible to convert an in-image position of the first portion in the first image IMG1 into a plane position in the vehicle coordinate system (X, Y, Z). Moreover, the scale information 191 indicates the correspondence relationship between the color (RGB) of the pixel on the first image IMG1 and the height (Z) in the vehicle coordinate system. Based on this correspondence relationship, it is possible to convert the color of the first portion in the first image IMG1 into the height (Z) of the first portion in the vehicle coordinate system (X, Y, Z).

Performing the reverse of the above-described conversion process makes it possible to convert the position (i.e., the plane position and the height) of the first portion in the vehicle coordinate system (X, Y, Z) into the information on the first portion in the first image IMG1.

As another example, the operator marks a second portion in the second image IMG2 by using the input device 250. The information processing device 260 acquires information on the second portion in the second image IMG2. The information on the second portion in the second image IMG2 includes an in-image position (pixel) of the second portion in the second image IMG2. Based on the camera parameter information 192, the information processing device 260 calculates a position of the second portion in the vehicle coordinate system (X, Y, Z) from the in-image position of the second portion in the second image IMG2. More specifically, the information processing device 260 performs inverse transformation of commonly known perspective projection transformation based on the camera parameter information 192.

Performing the reverse of the above-described conversion process makes it possible to convert the position of the second portion in the vehicle coordinate system (X, Y, Z) into the in-image position (pixel) of the second portion in the second image IMG2.

As described above, first coordinate conversion between the first image coordinate system (U1, V1) of the first image IMG1 and the vehicle coordinate system (X, Y, Z) is possible, and second coordinate conversion between the second image coordinate system (U2, V2) of the second image IMG2 and the vehicle coordinate system (X, Y, Z) is also possible. Therefore, coordinate conversion between the first image coordinate system (U1, V1) of the first image IMG1 and the second image coordinate system (U2, V2) of the second image IMG2 is also possible. Therefore, as shown in FIG. 7 described above, the information processing device 260 is able to automatically mark the corresponding portion in the second image IMG2 in response to the marking operation with respect to the first image IMG1. Similarly, as shown in FIG. 8 described above, the information processing device 260 is able to automatically mark the corresponding portion in the first image IMG1 in response to the marking operation with respect to the second image IMG2.

The information processing device 260 registers the marked portion (i.e., the first portion or the second portion) in the image IMG on the map information MAP of the predetermined area AR. As described above, the information processing device 260 acquires the position of the marked portion (i.e., the first portion or the second portion) in the vehicle coordinate system (X, Y, Z). The marking reference information REF includes the position orientation information 183 at the first timing at which the image IMG is acquired. The position orientation information 183 indicates the position and the orientation of the automated driving vehicle 100 in the map coordinate system (S, T) of the map information MAP. Based on the position orientation information 183, the information processing device 260 converts the position of the marked portion in the vehicle coordinate system (X, Y, Z) into a position in the map coordinate system (S, T). The information processing device 260 displays and superposes the marked portion in the map coordinate system (S, T) on the map information map.

### 4-4. Registration Process

The information processing device 260 registers the marked portion on the map information MAP based on the position of the marked portion in the map coordinate system (S, T). That is, the information processing device 260 updates the map information MAP. The information processing device 260 displays the updated map information MAP on the display device 240.

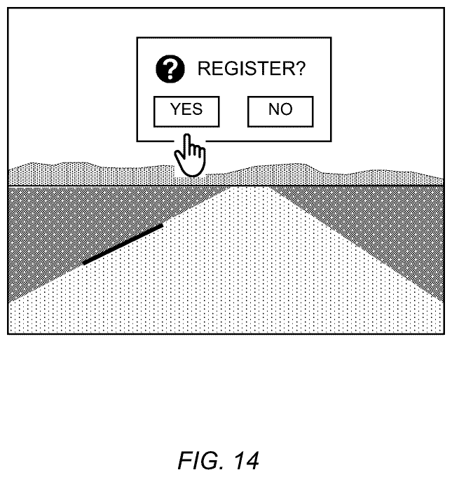

FIG. 14 is a conceptual diagram for explaining an example of the registration process. In the example illustrated in FIG. 14, the information processing device 260 inquires of the operator about whether or not to register the marked portion on the map information MAP, via the user interface 230. For example, an inquiry window is displayed on the display device 240. The operator approves or denies by using the input device 250. When the approval to register the marked portion on the map information MAP is received, the information processing device 260 registers the marked portion on the map information MAP and updates the map information MAP. On the other hand, when the operator denies, the information processing device 260 resets the marking operation. The operator may redo the marking operation.

### 5. Recommendation Function

A portion in the image IMG which is recommended to be registered on the map information MAP is hereinafter referred to as a “recommendation portion”. For example, the recommendation portion is an edge of a bank or a cliff. As another example, the recommendation portion is an obstacle (e.g., a fallen stone, a fallen object, and the like) on a road. As yet another example, the recommendation portion is an irregularity (e.g., a puddle, a depression, a large rut, and the like) on a road. The information processing device 260 may automatically extract the recommendation portion in the image IMG and propose registration of the recommendation portion to the operator. Such a function is hereinafter referred to as a “recommendation function”.

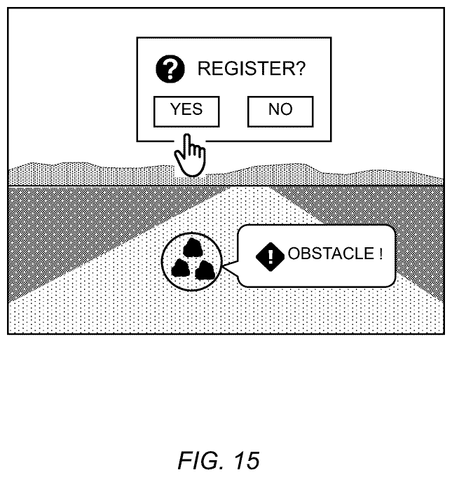

FIG. 15 is a conceptual diagram for explaining an example of the recommendation function. In the example shown in FIG. 15, an obstacle in the image IMG is automatically extracted as the recommendation portion. The information processing device 260 displays the image IMG on the display device 240 while indicating the recommendation portion in the image IMG. Further, the information processing device 260 inquires of the operator about whether or not to register the recommendation portion on the map information MAP, via the user interface 230. For example, an inquiry window is displayed on the display device 240. The operator approves or denies by using the input device 250. When the approval to register the recommendation portion on the map information MAP is received, the information processing device 260 registers the recommendation portion on the map information MAP and updates the map information MAP. The information processing device 260 displays the updated map information MAP on the display device 240.

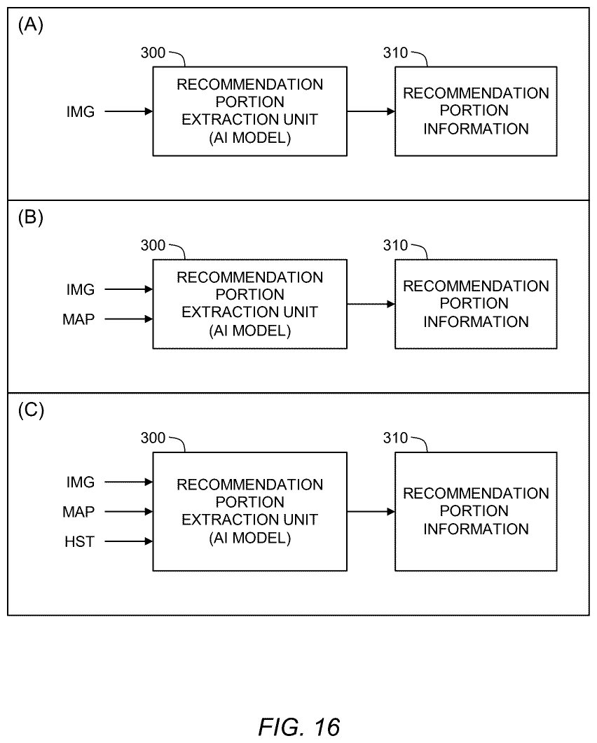

FIG. 16 is a block diagram showing examples of a functional configuration related to the recommendation function. A recommendation portion extraction unit 300 receives the image IMG and automatically extracts the recommendation portion in the image IMG. For example, a machine learning model (AI model) capable of detecting a recommendation portion in the image IMG is prepared in advance. The recommendation portion extraction unit 300 automatically detects and extracts a recommendation portion in the image IMG by inputting the image IMG to the machine learning model. The machine learning model may output an in-image position of the recommendation portion in the image IMG. The machine learning model may output a class (type) of the recommendation portion.

In an example (B) in FIG. 16, the recommendation portion extraction unit 300 also refers to the current map information MAP. The recommendation portion extraction unit 300 extracts only a recommendation portion that is not yet registered on the current map information MAP. The recommendation portion extraction unit 300 refrains from extracting a recommendation portion that is already registered on the current map information MAP again. This prevents unnecessary recommendation from being made.

In an example (C) in FIG. 16, the recommendation portion extraction unit 300 also refers to marking history information HST that indicates a history of past marking performed by the operator. Referring to the marking history information HST makes it possible to grasp which portion the operator mainly wants to mark. In other words, referring to the marking history information HST makes it possible to extract the recommendation portion to be recommended to the operator with higher accuracy. That is, accuracy of the recommendation is improved. The machine learning model may be trained based on the marking history information HST.

It should be noted that the recommendation portion extraction unit 300 may be included in the automated driving vehicle 100 or may be included in the control system 200. That is, the control device 160 of the automated driving vehicle 100 may automatically extract the recommendation portion in the image IMG, or the information processing device 260 of the control system 200 may automatically extract the recommendation portion in the image IMG.

Recommendation portion information 310 is information about the extracted recommendation portion. The recommendation portion information 310 includes an in-image position of the recommendation portion in the image IMG. The recommendation portion information 310 may include a class (type) of the recommendation portion.

The information processing device 260 of the control system 200 acquires the recommendation portion information 310. When the recommendation portion extraction unit 300 is included in the automated driving vehicle 100, the information processing device 260 acquires the recommendation portion information 310 from the automated driving vehicle 100 via the communication. The information processing device 260 displays the image IMG on the display device 240 and indicates the recommendation portion in the image IMG.

Further, the information processing device 260 inquires of the operator about whether or not to register the recommendation portion on the map information MAP, via the user interface 230. The operator approves or denies by using the input device 250. When the approval to register the recommendation portion on the map information MAP is received, the information processing device 260 registers the recommendation portion on the map information MAP and updates the map information MAP. The conversion from the in-image position of the recommendation portion in the image IMG to a position of the recommendation portion in the map information MAP is the same as that in the case of the marked portion (see FIG. 13). The information processing device 260 displays the updated map information MAP on the display device 240.

On the other hand, when the operator denies, the information processing device 260 does not register the recommendation portion on the map information MAP.

The operator may perform the marking operation by himself/herself while referring to the recommendation portion. That is, the operator may slightly modify the recommendation portion. The processing when the operator performs the marking operation is as described in the above Sections 4-3 and 4-4.

As described above, according to the present embodiment, the recommendation portion that is a portion in the image IMG and is recommended to be registered on the map information MAP of the predetermined area AR is automatically extracted. The control system 200 displays the image IMG on the display device of the user interface 230 while indicating the recommendation portion. Due to such the recommendation function, the operator is able to easily register (reflect) desired information on the map information MAP.

What is claimed is:

1. A control system for managing a predetermined area,
the control system comprising:
processing circuitry; and
an user interface, wherein
the processing circuitry is configured to:
acquire one or more images that are acquired by using a sensor mounted on an automated driving vehicle in the predetermined area and that indicate a situation around the automated driving vehicle in the predetermined area;
display the one or more images on a display device of the user interface;
receive an operation that is input through the user interface to mark a portion in the one or more images; and
register the portion marked in the one or more images on map information of the predetermined area.

2. The control system according to claim 1, wherein
the one or more images include a first image of a three dimensional structure around the automated driving vehicle in the predetermined area as viewed from above the automated driving vehicle.

3. The control system according to claim 2, wherein
in the first image, height of the three dimensional structure is represented by color.

4. The control system according to claim 2, wherein
the sensor includes a three dimensional measurement sensor configured to acquire data of the three dimensional structure around the automated driving vehicle, and
the first image is generated by converting the three dimensional structure into a two dimensional structure as viewed from above.

5. The control system according to claim 4, wherein
the first image is generated by the automated driving vehicle and transmitted from the automated driving vehicle to the control system.

6. The control system according to claim 1, wherein
the one or more images include a second image captured by a camera mounted on the automated driving vehicle in the predetermined area.

7. The control system according to claim 1, wherein
the one or more images include:
a first image of a three dimensional structure around the automated driving vehicle in the predetermined area as viewed from above the automated driving vehicle; and
a second image captured by a camera mounted on the automated driving vehicle in the predetermined area.

8. The control system according to claim 7, wherein
the processing circuitry is further configured to:
display the first image and the second image on the display device; and
receive an operation that is input through the user interface to mark a first portion in the first image; and
automatically mark a second portion in the second image, the second portion corresponding to the first portion.

9. The control system according to claim 7, wherein
the processing circuitry is further configured to:
display the first image and the second image on the display device; and
receive an operation that is input through the user interface to mark a second portion in the second image; and
automatically mark a first portion in the first image, the first portion corresponding to the second portion.

10. The control system according to claim 1, wherein
the processing circuitry is further configured to:
acquire conversion information for performing coordinate conversion between an image coordinate system of the one or more images and a vehicle coordinate system;
converting, based on the conversion information, an in-image position of the marked portion in the one or more images into a position in the vehicle coordinate system;
register the marked portion on the map information of the predetermined area based on the position in the vehicle coordinate system.

11. The control system according to claim 10, wherein
the one or more images include a first image of a three dimensional structure around the automated driving vehicle as viewed from above the automated driving vehicle,
the conversion information includes scale information indicating a correspondence relationship between a single pixel on the first image and an actual distance, and
the processing circuitry is further configured to:
receive an operation that is input through the user interface to mark a first portion in the first image; and
convert, based on the scale information, an in-image position of the first portion in the first image into a position in the vehicle coordinate system.

12. The control system according to claim 11,
in the first image, height of the three dimensional structure is represented by color,
the scale information further indicates a correspondence relationship between the color and the height, and
the processing circuitry is further configured to:
convert the color of the first portion in the first image into the height of the first portion in the vehicle coordinate system based on the correspondence relationship between the color and the height.

13. The control system according to claim 10, wherein
a map coordinate system is a coordinate system of the map information of the predetermined area,
the one or more images indicate a situation around the automated driving vehicle at a first timing, and
the processing circuitry is further configured to:
acquire position orientation information indicating a position and an orientation of the automated driving vehicle in the map coordinate system at the first timing;
convert, based on the position orientation information, the position in the vehicle coordinate system into a position in the map coordinate system, and
register the marked portion on the map information of the predetermined area based on the position in the map coordinate system.

14. The control system according to claim 1, wherein
the processing circuitry is further configured to:
automatically extract a recommendation portion that is a portion in the one or more images and is recommended to be registered on the map information; and
display the one or more images on the display device while indicating the recommendation portion.

15. The control system according to claim 14, wherein
the processing circuitry is further configured to:
inquire, through the user interface, whether or not to register the recommendation portion on the map information; and
in response to receiving approval to register the recommendation portion on the map information, register the recommendation portion on the map information.

16. A control system for managing a predetermined area,
the control system comprising:
processing circuitry; and
an user interface, wherein
the processing circuitry is configured to:
acquire one or more images that are acquired by using a sensor mounted on an automated driving vehicle in the predetermined area and that indicate a situation around the automated driving vehicle in the predetermined area;
automatically extract a recommendation portion that is a portion in the one or more images and is recommended to be registered on map information of the predetermined area; and
display the one or more images on a display device of the user interface while indicating the recommendation portion.

17. The control system according to claim 16, wherein
the processing circuitry is further configured to:
inquire, through the user interface, whether or not to register the recommendation portion on the map information; and
in response to receiving approval to register the recommendation portion on the map information, register the recommendation portion on the map information.
